(19) United States
(12) Patent Application Publication
(10) Pub. No.: US 2017/0306801 A1
(43) Pub. Date: Oct. 26, 2017

(54) METHOD FOR SHORTENING THE START-UP PROCESS OF A STEAM TURBINE

(71) Applicant: SIEMENS AKTIENGESELLSCHAFT, MÜNCHEN (DE)

(72) Inventors: ULRICH BEUL, Essen (DE); SVEN DREES, Neuss (DE); Tobias Hogen, Essen (DE); Yevgen Kostenko, Ratingen (DE); Daniel Liedtke, Mülheim an der Ruhr (DE); Oliver Stawarski, Neuss (DE); Andreas Stiehm, Remagen-Kripp (DE); Sebastian Zahn, Duisburg (DE)

(21) Appl. No.: 15/520,095

(22) PCT Filed: Oct. 5, 2015
(86) PCT No.: PCT/EP2015/072920

§ 371 Date: Apr. 19, 2017

(30) Foreign Application Priority Data
Oct. 23, 2014 (DE) 102014221563.3

(51) Int. Cl. F01K 13/02; F16J 15/40; F01D 11/06; F01D 25/10; F01D 11/04

(52) U.S. Cl. CPC F01K 13/02; F01D 11/06; F01D 25/10; F16J 15/40; F01D 11/04; F05D 2220/31; F05D 2260/85; F05D 2270/16; F05D 2270/303; F05D 2240/55

(57) ABSTRACT

A method for shortening the start-up process of a steam turbine is provided which has a turbine housing and turbine components which are provided inside the turbine housing. The turbine components during operation come into contact with hot steam which flows through the turbine housing and include a turbine shaft which passes axially through the turbine housing. Sealing regions, which during operation of the steam turbine are acted upon by seal steam, are formed between the turbine shaft and the turbine housing. Thermal energy is fed to the steam turbine during a shutdown of said steam turbine, wherein seal steam is fed to the interior of the turbine housing during the shutdown of the steam turbine in order to heat and/or to keep warm the turbine components which are provided in the interior of the turbine housing.

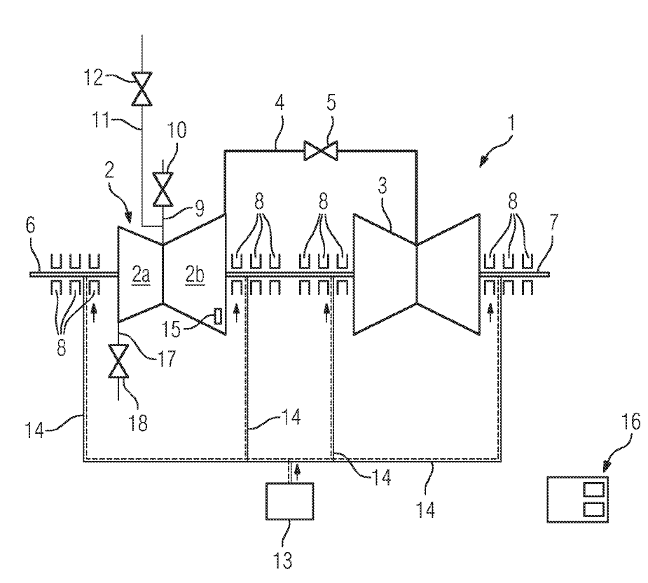

### CROSS-REFERENCE TO RELATED APPLICATIONS

This application claims priority to PCT Application No. PCT/EP2015/072920, having a filing date of Oct. 5, 2015, based off of DE Application No. 10 2014 221563.3 having a filing date of Oct. 23, 2014, the entire contents both of which are hereby incorporated by reference.

### FIELD OF TECHNOLOGY

The following relates to a method for shortening the start-up process of a steam turbine which has a turbine housing and turbine components which are provided inside the turbine housing, which turbine components during operation come into contact with hot steam which flows through the turbine housing and include a turbine shaft which passes axially through the turbine housing, wherein sealing regions, which during operation of the steam turbine are acted upon by seal steam, are formed between the turbine shaft and the turbine housing, and wherein thermal energy is fed to the steam turbine during a shutdown of the turbine.

### BACKGROUND

In steam power plants, the thermal energy of steam in a steam turbine is used for power generation. The steam which is required for this is produced in conventional power plants in a steam boiler from purified and treated water using fossil fuels. The thereby provided steam is then conducted through a superheater in order to increase the temperature of the steam and its specific volume. The superheated steam is expanded in the steam turbine. During this, thermal energy is converted into mechanical energy which is used for driving a consumer and especially a generator for generating electric energy. The expanded and cooled steam then flows into a condenser where it condenses as a result of heat transfer to the environment and as liquid water collects at the lowest point of the condenser. The condensed water is fed via corresponding pumps and preheating devices to a feed-water tank and from there is again conducted via a feed pump to the steam boiler.

Steam turbines are also used in solar power plants. These have solar generating units, for example in the form of parabolic reflectors which in their focal line have a pipeline for a heat transfer oil. In this focal line, the heat transfer oil is heated during solar radiation and is then brought into communication with water or steam via a heat exchanger. As a result of heat transfer, hot steam is produced and in a steam cycle drives the steam turbines of the solar power plant.

The known steam turbine plants are usually of multistage design in this case and have a high-pressure (HP-) turbine stage, an intermediate-pressure (IP-) turbine stage and a low-pressure (LP-) turbine stage which are exposed in succession to a throughflow of the steam. In this case, the HP-turbine stage and the IP-turbine stage are frequently combined, forming a steam turbine, and accommodated in a common turbine housing. This is connected on the outflow side via a crossover pipe to the LP-turbine stage which is designed as a separate turbine with a separate turbine housing. Formed at the axial ends of the turbine housing are shaft sealing regions which counteract a discharge of steam, or an air infiltration in the LP-turbine stage, through the annulus which is formed in each case between the turbine shaft and the turbine housing. Since the shaft seals have to operate in a contactless manner, a total separation of the interior of the turbine housing from the environment cannot be prevented. For this reason, seal steam is usually fed to the sealing region from the outside via a seal steam system. The continuous flow of seal steam in this case prevents an infiltration of ambient air into the turbine housing or an escape of steam from the turbine housing into the sealing regions.

Especially on account of the increase in the proportion of renewable energy sources in power generation, the utilization of power plants is to some extent variable. The requirements to be able to switch from a full-load operation, to a low-load operation right and up to the standby operation becomes increasingly important. Conversely, it ought to be possible to be able to change from a low-load operation or standby operation to a full-load operation again as quickly as possible in order to be able to cover peak loads. In this connection, it is necessary to keep the start-up time of the steam turbine which is to be kept in readiness for covering the peak load, i.e. the time which is necessary in order to bring the steam turbine from a standby operation or shutdown state to the full-load operation, as short as possible. Especially a cold start of a steam turbine leads to not insignificant start-up times, however. These arise from the necessity that the turbine housing and the turbine components which are accommodated therein, such as the rotor with the turbine shaft and the rotor wheels mounted thereon, have to be heated up as uniformly as possible in order to avoid undesirable thermal expansions and thermal stresses which result therefrom. In order to minimize the start-up times, it is proposed for example in EP 0 537 307 A1 to heat the turbine housing from the outside in standby operation or during a shutdown in order to make the turbine fully operational again within a short time when required.

Starting from the known art, an aspect relates to a method of the type referred to in the introduction by the start-up process of a turbine, and in this case especially of a steam turbine, can be shortened. Furthermore, an aspect relates to create a turbine for implementing the method.

### SUMMARY

An aspect relates to a method of the type referred to in the introduction by seal steam being fed to the interior of the turbine housing during the shutdown of the steam turbine in order to heat and/or to keep warm the turbine components which are provided in the interior of the turbine housing. The following is therefore based on the consideration of heating the turbine components which are provided inside the turbine housing, and in this case especially the turbine shaft, during a shutdown of the turbine by hot seal steam being directed into the turbine housing. During the introduction of the hot seal steam, the turbine shaft can be slowly rotated, i.e. at about 10 to 20 revolutions per minute, in order to uniformly distribute the added seal steam inside the turbine housing and to conduct cooled seal steam out of the turbine housing again. The heating by means of seal steam does not involve additional costs in this case providing the steam turbine is evacuated since during this period seal steam is fed continuously to the sealing regions between the turbine shaft and the turbine housing in any case.

The seal steam is preferably fed to the interior of the turbine housing at a temperature of at least 200° C., especially at least 250° C. and preferably at least 300° C., so that the turbine components, and in this case especially the turbine shaft, are kept at an appropriate temperature. In other words, the turbine components are kept at a temperature level which enables a start-up of the turbine under warm start conditions. As a result of this, excessive thermal stresses in the turbine shaft during the admission of live steam into the steam turbine can be avoided even after long shutdown periods.

The method is preferably applied in a steam turbine in which two turbine stages, specifically especially the high-pressure (HP-) turbine stage and the intermediate-pressure (IP-) turbine stage of the steam turbine plant, are provided in series in the turbine housing. In this case, a drainage pipe, which can be shut off, is usually connected to the turbine housing between the turbine stages and customarily connects the turbine housing to a condenser. In this case, according to the present invention the steam which is contained in the turbine housing is sucked out via the drainage line during the shutdown of the steam turbine and at the same time seal steam, which is fed to the sealing regions, is sucked from both axial end regions of the turbine housing into the turbine housing toward the drainage pipe. In other words, the seal steam, which is still fed to the sealing regions during the shutdown of the steam turbine, is sucked from the end regions of the turbine housing toward the central drainage pipe so that the turbine housing is exposed especially in a continuous manner to a throughflow of seal steam from its end regions.

While steam is being sucked out of the interior of the turbine housing, the steam lines which are connected on the inflow side and outflow side to the turbine housing and serve for the feed or for the discharge of hot steam during operation, are closed in the process.

In a development of the embodiments of the invention, it is provided that an internal temperature of the turbine and/or a temperature on the surface of a turbine component which is provided inside the turbine housing is detected and heating as a result of feeding seal steam during the shutdown of the turbine is initiated if the detected temperature lies below a predetermined limit value. In the case of this embodiment, provision is therefore made for temperature sensors or temperature detectors via which the internal temperature of the steam turbine or the temperature of a predetermined turbine component is detected. These temperature sensors can be introduced for example into the turbine housing by anyway existing accesses to the steam turbine in the form of drainage connections, manholes or the like. Accordingly, heating by feeding seal steam only takes place if the temperature in the turbine housing or the temperature of a predetermined turbine component lies at such a low level that a faster start-up process is no longer possible, i.e. heating of the components located in the turbine housing would still be necessary during the start-up process. Similarly, heating can also be prevented if the measured temperature exceeds a predetermined upper limit value. In other words, heating by feeding seal steam is only activated and deactivated in a deliberate manner in order to keep the temperature in the interior of the turbine housing or the temperature of the turbine components within a desired temperature range.

Apart from this, during the shutdown of the steam turbine the turbine housing can be provided in a known manner per se on its outer side with a thermal insulation and/or can be heated from the outside in order to counteract a dissipation of heat to the outside.

### BRIEF DESCRIPTION

Some of the embodiments will be described in detail, with reference to the following FIGURES, wherein like designations denote like members, wherein:

The drawing shows a schematic view of a steam turbine plant according to embodiments of the present invention.

### DETAILED DESCRIPTION

An exemplary embodiment of the invention is explained below with reference to the attached drawing. In the drawing, the single FIGURE shows a schematic view of a steam turbine plant 1 according to embodiments of the present invention. This comprises two steam turbines 2, 3 or steam turbine units which are connected in series, specifically an HP/IP-steam turbine 2 and an LP-steam turbine 3. In this case, the HP/IP-steam turbine 2 forms a high-pressure (HP-) turbine stage 2a and an intermediate-pressure (IP-) turbine stage 2b of the steam turbine plant 1, whereas a LP-steam turbine 3 constitutes the low-pressure (LP-) turbine stage of the steam turbine plant 1. To this end, the LP-turbine 3 is connected on the inlet side to the outflow side of the intermediate-pressure stage 2b of the HP/IP-steam turbine 2 via a crossover pipe 4. In this crossover pipe 4, provision is made for a shut-off valve 5 via which the crossover pipe 4 can be closed off.

The HP/IP-steam turbine 2 and the LP-steam turbine 3 have in each case a turbine shaft 6, 7 which are mounted in turbine housings—not shown in more detail—and are customarily sealed in relation to the turbine housings via corresponding sealing regions 8.

The HP/IP steam turbine 2 of the steam turbine plant 1 is connected on the inflow side to a live steam feed line 9. Arranged in this is a valve 10 via which said live steam feed line 9 can be shut off.

The HP-section 2a of the HP/IP-steam turbine is connected on the outflow side to a steam discharge line 17 which during nominal operation feeds the cooled HP-exhaust steam of the reheater to the boiler. Arranged in this so-called cold reheat line is a valve, in this case a check valve 18, via which the steam discharge line 17 can be shut off.

Furthermore, a drainage line 11 is connected to the turbine housing of the HP/IP-steam turbine 2 between the HP-stage 2a and the IP-stage 2b. Provision is made in this for a shut-off valve 12 via which the drainage line 11 can be opened or closed. The drainage line 11 serves for connecting the turbine housing to a condenser—not shown. In this case, a delivery device—not shown either—is provided in the drainage line 11 or is assigned to the condenser, via which steam can be sucked from the interior of the turbine housing and delivered to the condenser.

The steam turbine plant 1 also comprises a seal steam source 13 which feeds seal steam to the sealing regions 8 via corresponding seal steam lines 14.

Also provided inside the turbine housing of the HP/IP-turbine stage 2 are temperature sensors 15 which are data-technologically connected to a control device 16 via which all the functions of the steam turbine plant 1 are controlled. The temperature sensors 6 serve for detecting the temperature in the turbine housing.

During the starting up and warming up of the steam turbine plant 1, thermal expansions and thermal stresses associated therewith could occur in the turbine housings of the two steam turbines 2, 3 themselves and in the turbine components which are provided inside the turbine housing. These occur particularly in the turbine shafts 6, 7 since these have the largest mass. The problem is particularly severe in the HP-turbine stage 2a and in the IP-turbine stage 2b of the first steam turbine 2. In order to avoid such thermal stresses, during the shutdown of the first steam turbine 2 hot seal steam is fed to the interior of the turbine housing of this steam turbine 2 so that the turbine shaft 6 and also the additional turbine components which are provided in the turbine housing are kept at a temperature which ensures that excessively severe thermal stresses are avoided if the steam turbine plant 1 is put into operation again and therefore the first steam turbine 2 is exposed to the admission of live steam again. In this case, the turbine shaft 6 is slowly rotated so that the seal steam can be uniformly distributed in the interior of the turbine housing.

The feed of seal steam is carried out automatically if the temperature which is detected by the temperature sensors 15 falls below a predetermined limit value, and it is interrupted again if the determined temperature lies above an upper limit value. Alternatively, it is possible to introduce seal steam continuously into the turbine interior.

The feed of seal steam is carried out in this case in a way that via the drainage line 11 the seal steam, which is fed continuously to the sealing regions 8 even during the shutdown of the steam turbine 2, is sucked by means of the delivery device from the two end regions of the steam turbine 2 into the turbine housing. In the process, the live steam valve 10 shuts off the live steam feed line 9, and the crossover pipe 4 is closed off by means of the shut-off valve 5.

Consequently, the turbine housing is exposed to a throughflow of seal steam from the axial end regions of the turbine housing toward the middle, which seal steam is then sucked out via the drainage line 11 between the HP-turbine stage 2a and the IP-turbine stage 2b to the condenser.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1-8. (canceled)

9. A method for shortening the start-up process of a steam turbine which has a turbine housing and turbine components which are provided inside the turbine housing, which turbine components during operation come into contact with hot steam which flows through the turbine housing and include a turbine shaft which passes axially through the turbine housing, wherein sealing regions, which during operation of the steam turbine are acted upon by seal steam, are formed between the turbine shaft and the turbine housing, and
wherein thermal energy is fed to the steam turbine during a shutdown of said steam turbine,
wherein seal steam is fed to the interior of the turbine housing during the shutdown of the steam turbine in order to heat and/or to keep warm the turbine components which are provided in the interior of the turbine housing,
wherein the steam turbine has two turbine stages which are provided in series in the turbine housing, and a drainage line, which can be shut off, is connected to the turbine housing between the turbine stages, wherein
during the shutdown of the steam turbine the steam which is contained in the turbine housing is sucked out via the drainage line and at the same time seal steam, which is fed to the sealing regions, is sucked from both axial end regions of the turbine housing into the turbine housing toward the drainage line.

10. The method as claimed in claim 9, wherein the seal steam is fed to the interior of the turbine housing at a temperature of at least 200° C.

11. The method as claimed in claim 9, wherein during the sucking out of steam from the interior of the turbine housing via the drainage line the steam lines which are connected on the inflow side and outflow side to the turbine housing and serve for the conducting of hot steam during operation, are closed.

12. The method as claimed in claim 9, wherein during the introduction of seal steam with the steam turbine shut down, the turbine shaft is slowly rotated in order to uniformly distribute the seal steam in the interior of the turbine housing.

13. The method as claimed in claim 9, wherein the turbine housing is provided on its outer side with a thermal insulation during the shutdown and/or is heated from the outside.

14. The method as claimed in claim 9, wherein an internal temperature of the steam turbine and/or the surface temperature of a turbine component which is provided inside the turbine housing is detected and heating by feeding seal steam during the shutdown of the steam turbine is initiated if the detected temperature lies below a predetermined limit value.

15. The method as claimed in claim 14, wherein heating by feeding seal steam during the shutdown of the turbine is interrupted if the detected temperature lies above a corresponding upper limit value.

16. The method as claimed in claim 9, wherein the seal steam is fed to the interior of the turbine housing at a temperature of at least 250° C.

17. The method as claimed in claim 9, wherein the seal steam is fed to the interior of the turbine housing at a temperature of at least 300° C.
